(19) United States
(12) Patent Application Publication
(10) Pub. No.: US 2026/0233855 A1
(43) Pub. Date: Aug. 13, 2026

(54) A CONVEYOR SYSTEM

(71) Applicant: Power Stow International ApS, Gadstrup (DK)

(72) Inventors: Martin Vestergaard, Gadstrup (DK); Christian Dam, Gadstrup (DK)

(73) Assignee: Power Stow International ApS, Gadstrup (DK)

(21) Appl. No.: 19/474,795

(22) PCT Filed: Apr. 8, 2024
(86) PCT No.: PCT/EP2024/059487

§ 371 Date: Oct. 13, 2025

(30) Foreign Application Priority Data
Apr. 21, 2023 (DK) PA202300343

(51) Int. Cl. B64F 1/32; B64F 1/36

(52) U.S. Cl. CPC B64F 1/324; B64F 1/368

(57) ABSTRACT

A conveyor system for transporting baggage or cargo. The conveyor system comprises an extension conveyor for arranging on top of a first carrying medium of a main conveyor and a ramp for raising the carrying medium up-wards for facilitating the baggage or cargo from the main conveyor to the extension conveyor.

The present disclosure relates to a conveyor system for transporting baggage or cargo such as an aircraft loader, specifically an aircraft loader having an extension conveyor, or for baggage handling in an airport terminal for transporting baggage between a conveyor belt in the airport terminal and a baggage cart or for loading or unloading airport unit load devices (ULD) such as a container.

An example of an aircraft loader with an extension conveyor is disclosed in EP 1 667907B 1 , which is incorporated in the present disclosure by reference. The aircraft loader disclosed in EP 1 667 907 B1 comprises an extension conveyor and a ramp for facilitating or aiding that the baggage comes from the main conveyor belt and onto the extension conveyor and not simply moves into the extension conveyor and stays in a blocked position while the main conveyor belt rotates, i.e. there is a transport or movement of the baggage from the main conveyor belt to the extension conveyor.

If desiring to rotate or swing the conveyor to the right or to the left with respect to the main conveyor belt of the aircraft loader, the distance between the ramp and extension conveyer varies, and this may cause interruptions in the flow/transport of baggage, because baggage may get stuck or be blocked.

A first aspect of the present disclosure is:

A conveyor system for transporting baggage or cargo, said conveyor system comprising:
an extension conveyor for arranging on top of a first carrying medium of a main conveyor conveying said baggage or cargo during intended operational use, said carrying medium having a surface for supporting said baggage or cargo,
a ramp for raising said carrying medium upwards for facilitating said baggage or cargo from said main conveyor to said extension conveyor.

A second aspect of the present disclosure is:

A conveyor system for transporting baggage or cargo, said conveyor system comprising:
an extension conveyor for arranging on top of a first carrying medium of a main conveyor conveying said baggage or cargo during intended operational use, said carrying medium having a surface for supporting said baggage or cargo,
a ramp for raising said carrying medium upwards for facilitating said baggage or cargo from said main conveyor to said extension conveyor, said ramp pivotally arranged with a first center of rotation for rotating said ramp in a plane substantially parallel to said surface.

The surface is to be understood as the carrying surface, i.e. where the baggage or cargo rest while being transported by the first conveyor. This surface faces upwards. The terms upwards and downwards are to be understood relative to the normal position of the surface, i.e. the surface is supported by pullies at each end of the first conveyor. The ramp lifts the carrying medium locally upwards so that locally the surface is higher than if the ramp had not been there. Downwards is to be understood as a direction that is opposite upwards.

A plane substantially parallel to the carrying surface means that the angle between the plane and the carrying surface is not greater than 20 degrees.

In the following specific examples according to aspects of the present disclosure will be explained in more detail with reference to the accompanying drawings. The present disclosure may, however, be embodied in different forms than depicted below, and should not be construed as limited to any examples set forth herein. Rather, any examples are provided so that the disclosure will be thorough and complete, and will fully convey the scope of the invention to those skilled in the art. Like reference numerals refer to like elements throughout. Like elements will, thus, not be described in detail with respect to the description of each figure.

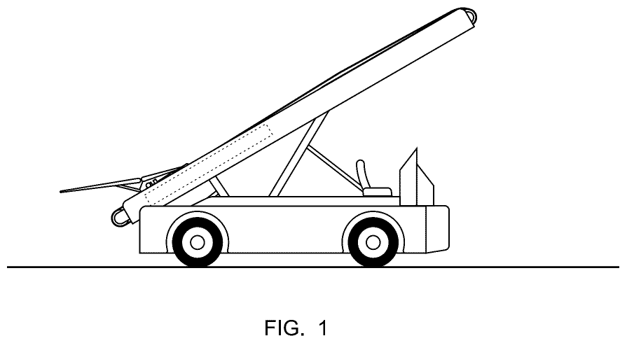

FIG. 1 shows an aircraft conveyor parked on the tarmac 12.

An aircraft loader is a ground support equipment (GSE) for bulk loading, i.e. stowing baggage without containers. It is a vehicle operated by an operator in a driver's cabin for driving the aircraft loader to and from the aircraft. It has a (main) conveyor comprising a first carrying medium (a main conveyor belt 14).

Specifically for an aircraft loader the conveyor can be raised to an inclined position by lifting the front end 16 of the conveyor belt. The backend 18 will remain at ground level, i.e. closer to the tarmac than the elevated front end.

The conveyor belt extends between the cargo hold of the aircraft and the ground level during loading and unloading. Typically, the baggage is to be transported between the cargo hold and a baggage cart.

The conveyor belt is stretching between a pair of drums, one of which may be driven by a motor such as an electric or hydraulic motor for pulling the conveyor belt. The belt forms a closed loop around the drums so it can continually rotate. The shape of the conveyor belt is an obround shape. The pair of drums are rotatably mounted to a first frame/main conveyor belt frame 20.

A so called extension conveyor 22 is arranged in a relationship with the carrying medium of the main conveyor, specifically on top of/above the carrying medium.

An effect of the extension conveyor is that the (loading or unloading) height is con-trolled such that baggage handling personnel does not have to lift baggage, but instead move the extension conveyor to a desired height-this height may vary during loading or unloading a baggage cart.

It may also be rotated/turned to the left or to the right of the main conveyor if a baggage cart for example is not parked direct behind the main conveyor. In such a case there may be a need to swing the extension conveyor to the side for avoiding that the baggage handler needs to carry the baggage, i.e. rotating the extension conveyor in a plane substantially parallel to the carrying surface of the main conveyor belt.

The extension conveyor comprises a second carrying medium for supporting baggage or packages.

The terms distal and proximal are to be understood relative to the direction of the travel of the carrying medium of the main conveyor, i.e. baggage conveyed on the carrying medium reaches the proximal end/front of the extension conveyor before it reaches the distal end/back.

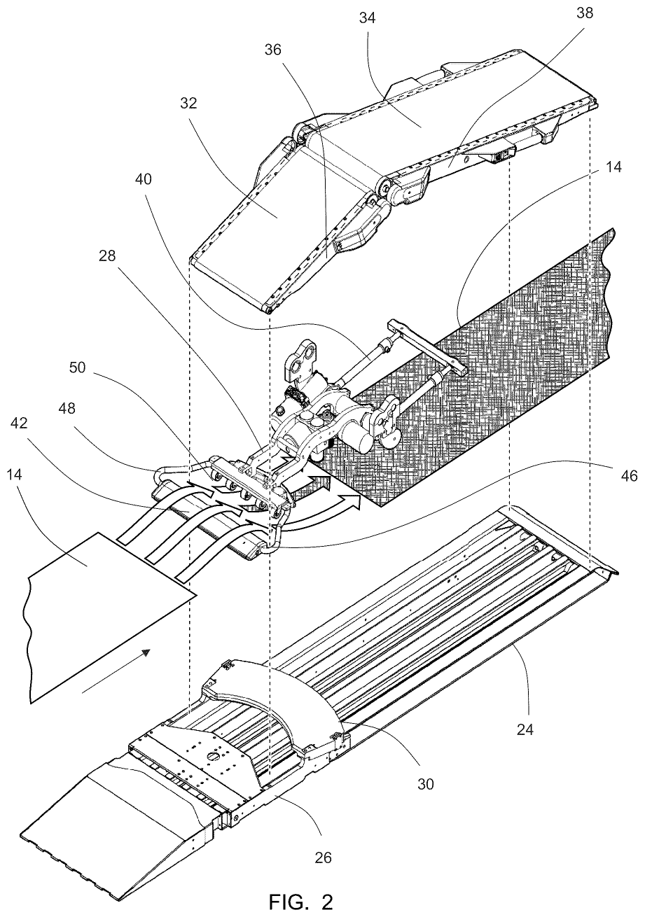

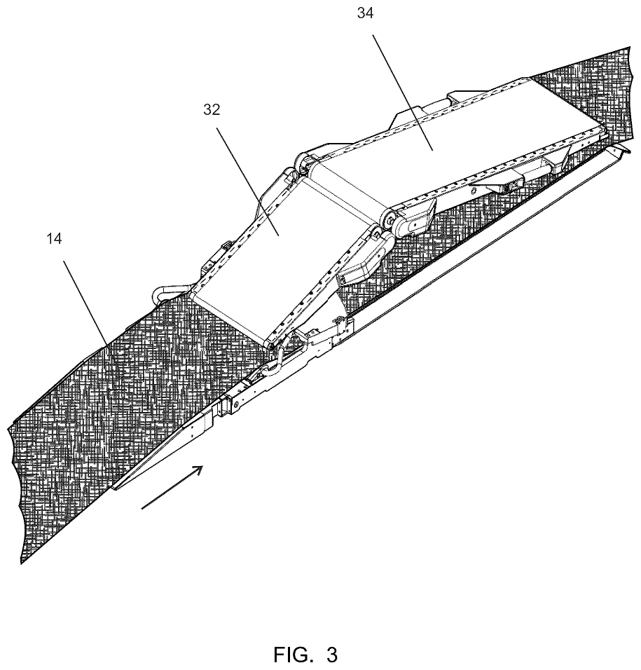

FIG. 2 shows an exploded view of part of the conveyor system, specifically the part including the extension conveyor, and FIG. 3 shows a non exploded view.

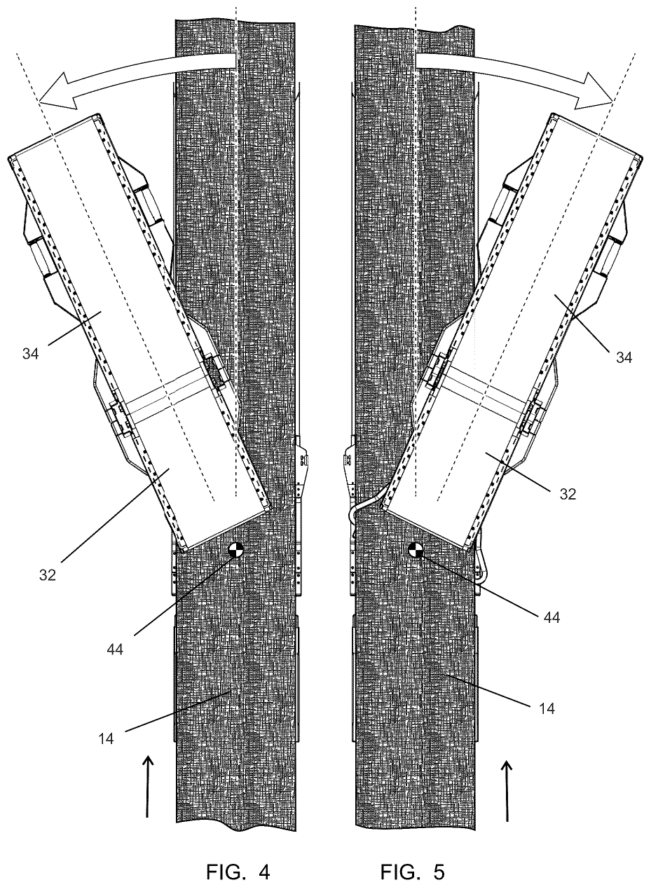

FIGS. 4 and 5 shows a top view where the extension conveyor has been turned to the left and to the right respectively.

The extension conveyor may have an extension conveyor frame (also termed base or table frame) 24 mounted to the main conveyor, specifically the main conveyor belt frame. For example, arranging the extension conveyor frame in the space inside the loop defined by the conveyor belt somewhere between the two drums.

The extension conveyor frame may be tapered (ramp shaped) at the proximal end, i.e. the end where the carrying medium comes into contact with the extension conveyor first. The height of the ramp increases as a function of distance/position in the direction of travel of the carrying surface (having a slope/inclination). The direction of travel is illustrated with the arrow next to the main conveyor belt.

The carrying medium will be lifted up by the ramp and move on top of the extension conveyor frame, i.e. the main conveyor belt will be stretched between the first drum of the main conveyor, the extension conveyor frame, and the second drum of the main conveyor, i.e. the main conveyor belt will no longer have an obround shape when the extension conveyor frame is mounted to the main conveyor.

The extension conveyor may comprise a sleigh 26 mounted to the extension conveyor frame for moving the extension conveyor back and forth along the main conveyor, i.e. in the longitudinal direction of the main conveyor.

The sleigh may be moved back and forth by means of a cogged belt drive mechanism.

A rotatable frame 28 is mounted to the sleigh for rotating the extension conveyor to the left and to the right with respect to the main conveyor belt.

The sleigh may comprise a curved part 30 with a radius (the curved part may be shaped like an annular section (with opposite sides parallel to each other).

A cogged drive belt may be arranged between the curved part and the rotatable frame for moving the rotatable frame.

The extension conveyor may comprise a short conveyor belt 32 and a longer conveyor belt 34, i.e. two conveyor belt with one being longer than the other. A plurality of rollers/drums may be used as carrying medium instead of conveyor belts. A single conveyor belt may also be used.

The short conveyor belt may be supported by a pair of drums rotatably mounted to a first conveyor belt frame 36 (one of the drums being a drive pulley). The first conveyor belt frame may be mounted to the rotatable frame.

The long conveyor may be supported by a pair of drums rotatably mounted to a second conveyor belt frame 38 (one of the drums being a drive pulley). The second conveyor belt frame may be mounted to the rotatable frame.

A linear actuator 40 such as a piston mechanism may be used to elevate the long conveyor.

The aircraft loader comprises a ramp 42 (may also be termed bump) for given the main conveyor belt a “hump” shape just before the carrying medium of the extension conveyor (seen in the direction of travel of the main conveyor belt), i.e. for lifting the main conveyor belt upwards at a position before the carrying medium of the extension conveyor, specifically before the short conveyor. Thus, the carrying medium of the main conveyor will experience an elevation when coming into contact with the extension conveyor frame and when coming into contact with the ramp.

The ramp may have the shape of a partial cylinder, or it may be tapered, i.e. in general such that the height of the ramp increases as a function of distance/position in the direction of travel of the carrying surface (having a slope/inclination).

The ramp may have a longitudinal axis/centerline that is orthogonal to the direction of travel of the carrying surface. The ramp may have a ramp edge facing the extension conveyor.

The carrying medium of the extension conveyor may have a (second) edge facing the ramp. This edge constitutes the proximal end of the carrying medium of the extension conveyor where the baggage or cargo comes onto the carrying medium of the extension conveyor.

It is preferred that the longitudinal axis of the ramp or the ramp edge is substantially parallel to the edge of the carrying medium of the extension conveyor when the two rotates. Substantially parallel means that the angle between the two do not deviate with more than 20 degrees.

The center of rotation 44 for the extension conveyor may substantially coincide with the center of rotation for the ramp, i.e. the one center of rotation may be within a radius/distance of no more than 30 cm such as 20 cm or 10 cm from the other center of rotation.

When the centers of rotations are the same the second edge will be parallel and across from the ramp edge when the extension conveyor is rotated to a given angle. Across means that when considering the tangent to the right end of the ramp and the tangent to the left end of the ramp, the second edge will be between these two tan-gents.

When the centers of rotations are different from each other the second edge will be substantially parallel with the ramp edge when the ramp and the extension conveyor are rotated to substantially the same angles (+/−10 degrees).

A specific solution for rotating the ramp may be to connect the ramp and the extension conveyor to each other, i.e. such that they are fixed to each other. In this way they will rotate/turn together when one of them is turned, i.e. they constitute an assembly that may be rotated by a motor. The motor may rotate the ramp or the extension conveyor, and when the one rotates the other rotates as well.

Specifically, the rotatable frame/extension conveyor may comprise a first arm 46 connected to the ramp at the right hand side of the ramp and a second arm 48 connected to the ramp at the left hand side of the ramp. In this way the ramp will rotate when the extension conveyor rotates and the rotational/angular velocity will be the same. In this way it may be ensured that the ramp and extension conveyor do not rotate to different angles.

Alternatively, a first motor may be use to rotate the ramp, and a second motor may be used to rotate the extension conveyor. A first sensor may be used for determining the angle of rotation of the ramp, and a second sensor may be used for determining the angle of rotation of the extension conveyor. Preferably these two angles are to be substantially equal (not deviate from each other with more than 20 degrees such as 10 or 5 degrees). Knowing one of the angles may be used to rotate either the ramp or extension conveyor so that the angles are substantially equal.

Any electric wiring for the extension conveyor may go through the ramp at the center of rotation and out to one of the arms and proceed further trough one of the arms to the extension conveyor.

The extension conveyor, specifically the rotatable frame, may comprise a plurality of caster wheels including a first caster wheel 50 arranged between the upper sur-face/transport surface of the main conveyor belt and the extension conveyor, specifically between the upper surface of the main conveyor belt and the lower surface of the short conveyor belt.

The caster wheels are to direct/force the main conveyor belt downwards, i.e. instead of contacting the extension conveyor the caster wheels are positioned such that it will be the caster wheels that the main conveyor belt comes into contact with.

The caster wheels are arranged adjacent/next to the edge of the extension conveyor, i.e. the edge of the carrying medium of the extension conveyor.

The caster wheels are arranged on a straight line orthogonal to the longitudinal axis of the extension conveyor, i.e. the axis extending through the proximal end and the distal end of the extension conveyor. Said in other words, orthogonal to the longitudinal direction of the main conveyor when the extension conveyor is not rotated.

A caster wheel is per definition a wheel that is rotatably mounted to its support, i.e. the wheel suspension may rotate around an axis, preferably orthogonal to the wheel axis, i.e. the axis that the wheel rotates around. In this case the first caster wheel is rotatably mounted to the rotatable frame, and preferably all of the caster wheels are rotatably mounted to the rotatable frame. Thus, the plurality of caster wheels are free to rotate which means that they do not force the main conveyor belt in a direction away from the running axis. If the belt were to be forced in a direction away from its running axis the belt will be stressed and wear down faster.

Now follows a set of items, which constitute aspects of the present disclosure which may be considered independently patentable and as such the following sets form basis for possible future sets of claims:
1. A conveyor system for transporting baggage or cargo, said conveyor system comprising:
an extension conveyor for arranging on top of a first carrying medium of a main conveyor conveying said baggage or cargo during intended operational use, said carrying medium having a surface for supporting said baggage or cargo,
a ramp for raising said carrying medium upwards for facilitating said baggage or cargo from said main conveyor to said extension conveyor.
2. The conveyor system according to any of the preceding items, said ramp pivotally arranged with a first center of rotation for rotating said ramp in a plane substantially parallel to said surface.
3. The conveyor system according to any of the preceding items, comprising said main conveyor and said carrying medium.
4. The conveyor system according to any of the preceding items, said ramp and said extension conveyor connected to each other for rotating together.
5. The conveyor system according to any of the preceding items, said extension conveyor pivotally arranged with a second center of rotation for rotating said extension conveyor to the left or to the right with respect to said main conveyor belt.
6. The conveyor system according to any of the preceding items, said first center of rotation being substantially equal to said second center of rotation.
7. The conveyor system according to any of the preceding items, comprising a first motor for rotating said ramp, a second motor rotating said extension conveyor, a first sensor for determining the angle of rotation of said ramp, and a second sensor for determining the angle of rotation of said extension conveyor.
8. The conveyor system according to any of the preceding items, said extension conveyor comprising a second carrying medium such as a conveyor belt.
9. The conveyor system according to any of the preceding items, said first carrying medium constituting a main conveyor belt.
10. The conveyor system according to any of the preceding items, said extension conveyor arranged on top of said surface.
11. The conveyor system according to any of the preceding items, comprising a sleigh for supporting said extension conveyor and moving said extension conveyor along said main conveyor.
12. The conveyor system according to any of the preceding items, said extension conveyor comprising a plurality of caster wheels.
13. The conveyor system according to any of the preceding items, said plurality of caster wheels arranged between said surface and said extension conveyor.
14. The conveyor system according to any of the preceding items, said plurality of caster wheels arranged for directing said main conveyor belt downwards.

1. A conveyor system for transporting baggage or cargo, the conveyor system comprising:
an extension conveyor arranged on a first carrying medium of a main conveyor conveying the baggage or cargo during operational use, the first carrying medium having a surface for supporting the baggage or cargo; and
a ramp for raising the first carrying medium upwards for facilitating the baggage or cargo from the main conveyor to the extension conveyor, the ramp pivotally arranged with a first center of rotation for rotating the ramp in a plane substantially parallel to the surface.

2. The conveyor system according to claim 1, further comprising the main conveyor and the first carrying medium.

3. The conveyor system according to claim 1, the ramp and the extension conveyor connected to each other for rotating together.

4. The conveyor system according to claim 1, the extension conveyor pivotally arranged with a second center of rotation for rotating the extension conveyor with respect to the main conveyor.

5. The conveyor system according to claim 4, the first center of rotation being substantially equal to the second center of rotation.

6. The conveyor system according to claim 1, further comprising a first motor for rotating the ramp, a second motor rotating the extension conveyor, a first sensor for determining an angle of rotation of the ramp, and a second sensor for determining the angle of rotation of the extension conveyor.

7. The conveyor system according to claim 1. the extension conveyor comprising a second carrying medium

8. The conveyor system according to claim 1. the first carrying medium constituting a main conveyor belt.

9. The conveyor system according to claim 1. the extension conveyor arranged on the surface.

10. The conveyor system according to claim 1, further comprising a sleigh for supporting the extension conveyor and moving the extension conveyor along the main conveyor.
